(19) United States
(12) Patent Application Publication
(10) Pub. No.: US 2005/0017863 A1
(43) Pub. Date: Jan. 27, 2005

(54) Emergency alert alarm locator

(76) Inventor: Martha H. Woods, Pearl River, LA (US)

Correspondence Address: Martha H. Woods, P.O. Box 880, Pearl River, LA, 70452, US

(21) Appl. No.: 10/627,127

(22) Filed: Jul. 25, 2003

(51) Int. Cl. G08B 1/08

(52) U.S. Cl. 340/539.1

(57) ABSTRACT

An emergency alarm alert device that has a dual control consisting of one remote control and one manual control. Both controls may activate the alarm to arm and disarm when receiving the selected signal from the controller. The device includes an alarm sound as an audio signal and a light as a means of a visual signal. The alarm device may be used by children as young as five years of age up to the elderly as a means of receiving emergency assistance when required. The alarm device consists of a manual control to be used to activate the alarm if and when the batteries are not functioning in the remote control. The alarm device is provided power by using batteries in order to be functional if the electricity is not operating such as during hurricanes, earthquakes, automobile accidents and many other uses. The transmitter and receiver units are pre-factory set, to send and detect a coded signal, whereby the receiver unit only responds to the transmitter unit sending the coded signal.

### BACKGROUND OF INVENTION

The invention disclosed herein relates to an emergency alarm device that pinpoints the location of the emergency. The designer seeks to provide an alarm device that will achieve a high response with sound and light function in certain situations such as a sudden oncoming illness, a lost child or accident. The person will be able to affect their own rescue by activating the alarm device. The emergency alert alarm device has a dual control, one remote control, and one manual control located on the side of the device. The manual control is an added precaution in case the batteries in the remote have deteriorated or other reasons. The invention has a preset code during manufacture that will only allow the unit being activated to respond to its command. This will prevent the activation of any other devices in a close proximity of responding all at the same time.

### FIELD OF THE INVENTION

The present invention refers to an alarm device for emergency use by giving an alarm signal and a visual device to summon help in the event of an emergency and a rescue is necessary.

### BRIEF SUMMARY OF THE INVENTION

It is the object of the inventor to provide an emergency call signal for anyone to summon help at any time.

A second object of the invention is to provide an emergency device that allows assistance or rescue to take place without delay.

A third object of this invention is to provide a device that may be reliable and economical and of a size that is compatible to everyone.

A fourth object of this invention is to summon assistance to anyone that may require it especially in the case of emergencies.

A fifth object of this invention is to show it can be tailored to each situation. For example, if you are a victim and cannot leave, this alarm device can be put in action to alert neighbors or others you are in need of help immediately.

Thus, according to this invention if the user is unable to call for help verbally, the emergency alarm will produce a summons of distress by signaling with a sound or light. It is obvious to a person skilled in the art that various alterations and modifications are possible without departing from the scope of the present invention which is set forth in the claims.

### DETAILED DESCRIPTION OF THE INVENTION

The emergency alert locator device of the present invention is comprised of two units, a transmitter unit that sends an activation signal when an on/off push button is activated, this unit is on a cord that can be worn by a person at all times, the receiver unit can be fastened to an object inside, such as a glass of window, or outside a door, post, or fence. The transmitter has a light as a visual indicator that is illuminated each time the user activates the transmitter. The transmitter also has a separate alarm push button as an audio indicator that is activated each time the user activates the transmitter.

Preferably, the light is provided with a lens around the perimeter of the receiver unit so that it is more visually prominent and can be seen at all angles from anyone outside. The size and location may, of course, be altered to present a different market appearance or to allow for different engineering specifications as needed. Alternatively, the transmitter and receiver may be pre-coded with unique signals during manufacture. In these manners, the receiver only responds to its associated transmitter, and each transmitter/receiver pair can be initialized for anyone of a plurality of different locations.

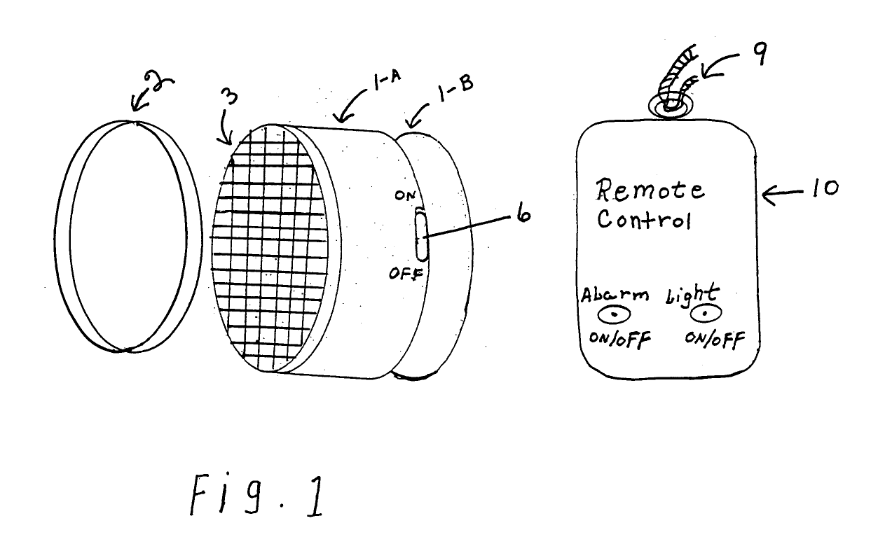

FIG. 1, shows a side view of the emergency alert alarm device in its assembled form along with the remote control 10. This device is to be used for pinpointing location such as addresses of houses and apartments but would be helpful when used in mobile homes, RV's, on the bow of some boats to signify that an emergency situation is occurring and immediate help is required. This side view of the invention also shows the manual slide on/off switch 6 that can be used to activate the device when the remote cannot be used. The main housing comprises two parts 1A and 1B that can be unscrewed for easy access of changing batteries. The front lens 3 is shown as the lens to emit the flashing light when the device is activated. The remote control comprises two parts a front and rear section 10 comprises two parts a front and rear section that will provide easy access for changing batteries and can be re-assembled by a snap lock at top and bottom to close it. The remote control 10 shows aperture at the top of the casing where a cord can be threaded thru to provide a way for persons to wear on a belt loop or around their neck or wrists, fastened to a chair arm or other numerous ways for attachment so as to be within easy reach.

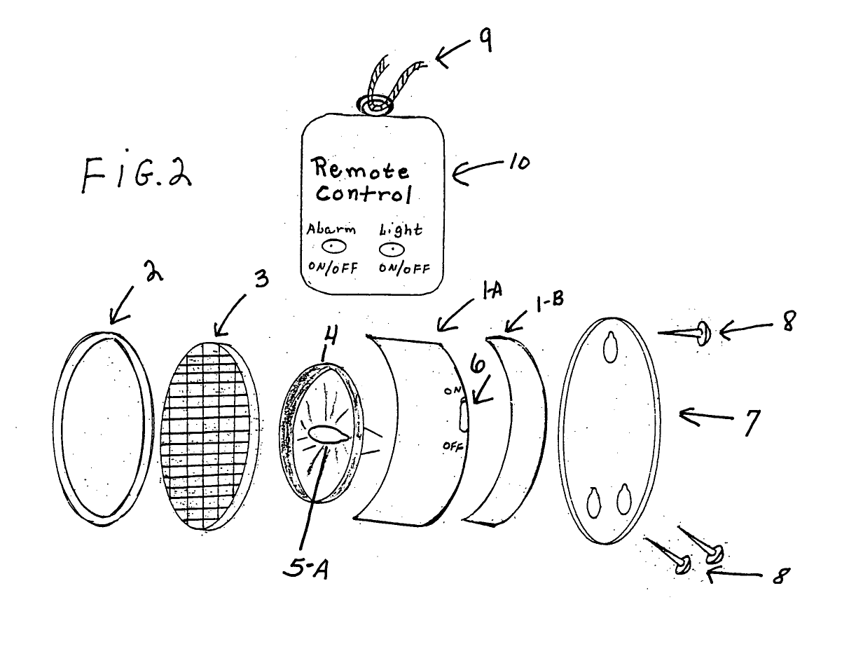

FIG. 2, illustrates another embodiment of the receiver showing the device to have a main housing 1A and 1B of two complimentary parts enclosing the internal circuitry. The locator device of the present invention shows the external embodiments consisting of a clear double sided adhesive ring 2 for installing on a glass door or window a lens 3 to emit a flashing light, preferably the lens would be of a design and depth to be viewed from all angles, 4 is a reflector disk that will fit into the main housing and can be secured in place by inserting it into two notches located on each side of the disk, 5 is a light bulb that snaps into the hole of the reflector disk 4 this bulb 5 can be of a quality that can provide 2,000 hours of illumination. This is provided for such emergencies as off the road, out of plain sight emergencies that would provide help to aerial search parties and ground searches, 6 is a manual on/off slide control that can be used to activate the receiver unit when the remote may not be operable the back installation plate 7 is provided as a means of installing the device outside on a door or post especially in very rural area or on a long driveway entrance to pinpoint the location of an emergency.

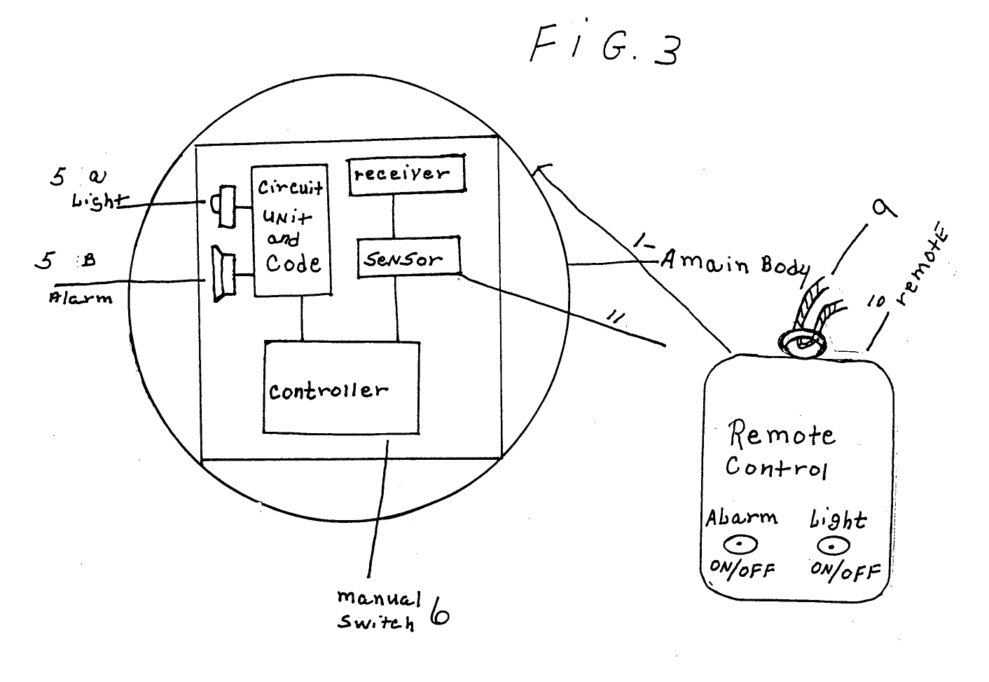

FIG. 3, illustrates the main housing 1A and 1B with a perspective view of the internal circuitry of this invention. The housing contains the circuitry for the light 5A and the alarm 5B the area for a preset code 13 has been included in this area, 6 is the controller to activate which of the embodiments the user may prefer at the time of activation, the light 5A and the alarm 5B, or only the light 5A or only the alarm 5B. These preferred embodiments are activated by a push button on/off switches 5A and 5B, one separate switch for each function. The remote control housing 10 shows an aperture at the top of the device thru which a cord 9 can be threaded to wear on a persons belt loop, wrist or around the neck if so desired, it also provides the accessibility to place it within easy reach of almost anyone. The internal circuitry with a receiver 12 to accept the command signals sent from 10 or the manual control 6 the controller is to activate the light 5A and the alarm 5B and detect the coded signal to cause a response only to the unit being activated.

This invention is so designed to simplify installation and use for the wide range in ages it will appeal to.

It will be recognized by those skilled in the art that the locator system of the invention has a wide application for use in identifying locations, and that numerous modifications are possible in light of the above disclosure. For example, the size, shape and color of the transmitter and receiver units may be modified in any number of ways to present a different marketing presentation or to accommodate different engineering specifications. Numerous other modifications and variations are possible within the disclosed principals of the invention. All such modifications and variations are considered to be within the spirit and scope of the invention as defined in the claims.

1. An emergency alarm device comprising:
a housing having opposing front and rear sides, said alarm being fastened to a door or window that is visible from the outside and is obvious to anyone.
an emergency alarm device that is composed of front and rear sides that has a remote control and a manual control.
an emergency alarm device that having control to activate the alarm when the command is given by the remote control or manual control that will arm and disarm the alarm.
a signaling device coupled to the control circuit and responsible thereto to provide an audio visual alarm signal.

2. An alarm signal according to claim 1 wherein said alarm unit comprises two signals for immediate emergency rescue by emergency personnel or bystanders.

3. An alarm signal according to claim 2 wherein in said prescribed alarm is produced by an audio alarm signal.

4. An alarm signal according to claim 2 wherein said prescribed alarm is produced by a visual signal as to pinpoint the exact location that emergency rescue is required.

5. An emergency alarm device that can be activated to assume its armed and unarmed states by using a remote control or a manual control as a means of function.
an emergency alarm device that can be activated by a person that will produce a signal by sound or light.
an alarm triggering means including at least one sensor for activating the device upon receiving the command from the control switches

6. An emergency alarm device that provides a remote control for persons that are handicapped and may be kept on the person at all time.
an emergency alarm device that provides only a visual signal if needed without activating the alarm signal, such as a case of domestic abuse taking place or a robbery taking place and it is safer not to let the intruder know someone is in the house or area

7. An emergency alarm device according to claim 6 that may be adapted for use as is necessary to provide emergency assistance the quickest and safest way possible.

8. An emergency alarm device according to claim 6 that is powered by a battery source as to be operable during times electricity may be unavailable such as hurricanes, earthquakes, automobile accidents and numerous other occasions that are too numerous to list.

9. An emergency alert signal that is compatible to 911 to pinpoint exact location and dispatcher can be informed the emergency alert signal is activated to speed assistance for emergency personnel; whether it is fire department, police or medical personnel required.

10. An emergency alarm device that can be equipped with a code so only the device activated will send out signals, especially in the close proximity such as apartments, classrooms, offices and other close spaces.
